(19) United States
(12) Patent Application Publication
(10) Pub. No.: US 2009/0007218 A1
(43) Pub. Date: Jan. 1, 2009

(54) Switched-Based Network Security

(76) Inventor: Scott M. Hubbard, Santa Clara, CA (US)

Correspondence Address: BLAKELY, SOKOLOFF, TAYLOR & ZAFMAN, LLP, SEVENTH FLOOR, 12400 WILSHIRE BOULEVARD, LOS ANGELES, CA, 90025-1026, US

(21) Appl. No.: 11/772,131

(22) Filed: Jun. 30, 2007

(51) Int. Cl. H04L 9/00; G06F 17/00

(52) U.S. Cl. 726/1; 726/11

(57) ABSTRACT

Traffic sent from a network endpoint is redirected and the network endpoint is tested for compliance with a security policy. If the network endpoint is in compliance with the security policy, an access policy is generated to allow the network endpoint to access the network without any traffic redirection.

### FIELD

Embodiments of the invention relate to network security. More particularly, the invention relates to network endpoint security.

### BACKGROUND

Hacking is a term that is often used to describe the acts of a user who trespasses on computer systems for any number of reasons. Oftentimes, intruders hack into a system or network of systems (“system”) with the intent to launch some form of attack against the system. An attacker, as used herein, refers to any user, host system, or remote host machine that hacks, trespasses, or intrudes onto a system and attempts to compromise the integrity or performance of the system. Attackers can be very sophisticated and difficult to detect.

Endpoint devices are typically not secure, and attackers know it. Decentralized attacks leverage the endpoint as the point of entry into the network. The enormous number of worms, Trojans, and spyware recently introduced attest to this method of attack. Network and security administrators are deluged by the many variants of MyDoom, Netsky, Sober, Sobig, Bagle, Phatbot, Witty, Blaster and countless others.

Network comprises via endpoint devices are difficult and expensive to fix. Most networks employ some form of network security to help against many of the attacks discussed above. Anti-virus software and personal firewalls are insufficient to effectively secure endpoint devices before they have access to network resources. Furthermore, many of today's network security systems need to be “in-line” with the network to mitigate threats and can, therefore, end up being bottlenecks or points of failure in the network.

### SUMMARY

Embodiments of the invention allow administrators to create access policies that define which applications and services are permitted on endpoint devices and specify the actions to be taken when endpoint devices do not comply. When a device connects to the network, traffic from the endpoint device is redirected to a security device and the endpoint device is tested for compliance. Based on the testing, the endpoint device is either quarantined or access policies are automatically applied to certify that the device is in compliance. Once an endpoint device is compliance certified, traffic from the endpoint device is no longer redirected to the security device. A non-compliant endpoint device can be remediated automatically (e.g., through integration with patch management systems), through a scheduled repair, or via end user self remediation.

Access policies consist of one or more tests to assess operating system integrity, verify that key hotfixes and patches have been installed, verify that anti-virus and other security applications are present and up to date and detect the presence of other malware. Access policies also test for incidences of potentially dangerous applications such as file sharing, Peer-to-Peer or spyware. Administrators can create custom tests through an application program interface (API).

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1 illustrates a security device that is physically inline with a network

FIG. 2 illustrates a configuration of a network according to some embodiments.

FIG. 3 illustrates access control lists (ACLs) located on a switch.

FIG. 4 illustrates various hosts on different network subnets.

FIG. 5 illustrates states of an ACL table.

FIG. 6 illustrates a configuration of a network according to some embodiments.

FIG. 7 illustrates a network having a security administrator

FIG. 8 illustrates modules according to some embodiments.

FIG. 9 illustrates a process according to some embodiments.

### DETAILED DESCRIPTION

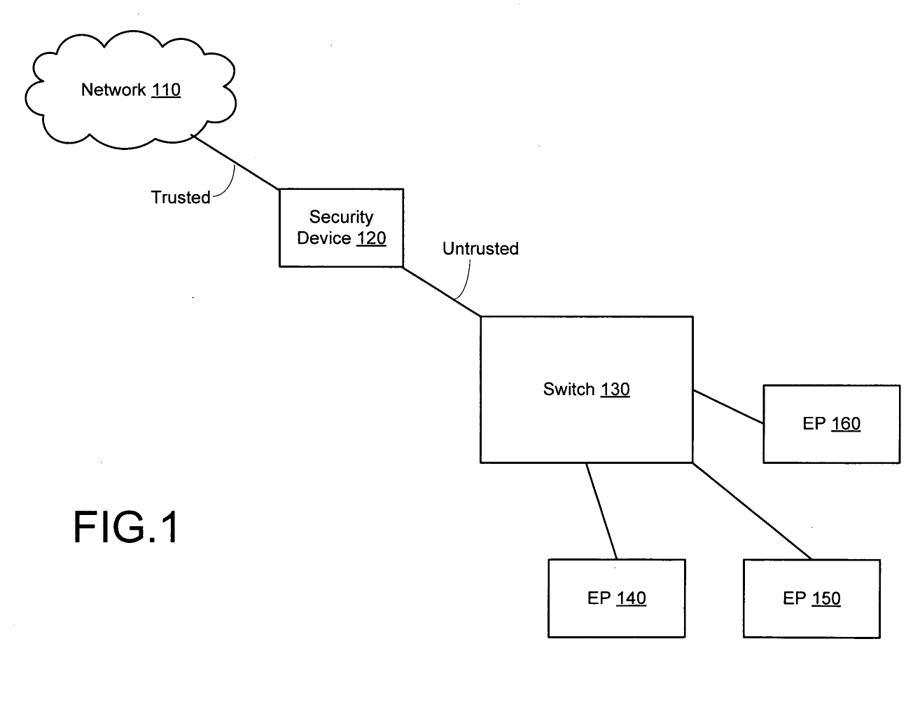

A security device, as used herein, includes any device that enables, enforces, and/or accommodates endpoint security in a network. FIG. 1 illustrates an example of a security device used in a network (e.g., Internet, local area network (LAN), wide area network (WAN), etc.). Security device 120 is located between network 110 and endpoints 140, 150 and 160, which are connected to switch 130. When any endpoint on the untrusted side of security device 120 attempts to communicate outside the switch (e.g., send traffic out to network 110 or to another endpoint), security device 120 will block the traffic and instruct the endpoint that it needs to be tested.

Once an endpoint has been tested, a firewall rule might be created that permits the endpoint to send outbound traffic and receive inbound traffic to be sent to the host. However, security device 120, as configured in FIG. 1, is a single point of failure. Thus, embodiments of the invention are configured such that security devices implementing endpoint security are virtually inline, rather than being physically inline. In other words, it is not necessary for traffic to pass through a security device in order to reach a destination.

To enable virtual inline operation, an access control list (ACL) is added to the VLANs or ports associated with the various endpoint devices. This default ACL requires all traffic from an endpoint to be redirected to the security device. The security device then instructs the endpoint that it needs to be tested. For example, the security device might seize control of any web sessions and present a web page instructing the endpoint user that the endpoint needs to be tested. Once the endpoint has been tested successfully (i.e., the endpoint complies with the security policy), the security device creates a dynamic ACL that permits the compliant endpoint to send outbound traffic to the network. This dynamic ACL is added to a table on the switch and the switch subsequently enforces the rule.

In some embodiments, endpoints are periodically re-tested to ensure that they are still in compliance with the security policy. If an endpoint becomes unavailable for testing or fails a test, the security device removes the dynamic permit ACL rule from the table, which effectively quarantines the endpoint. In other words, without the permit ACL rule, the endpoint is controlled by the default rule which redirects all traffic to the security device.

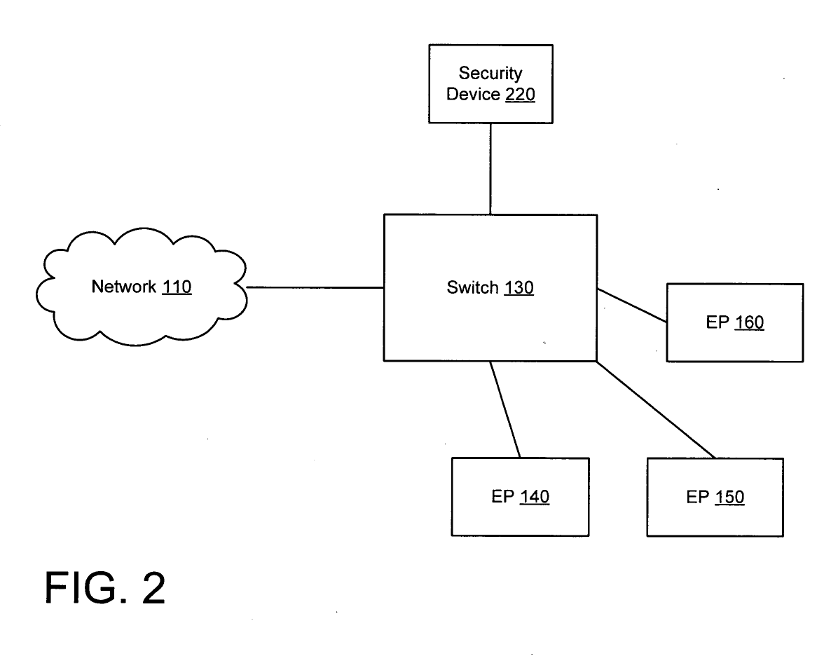

FIG. 2 illustrates a network configuration according to some embodiments. Security device 220 is connected to switch 130 but it is not physically inline between switch 130 and network 110. This virtually inline configuration permits security device 220 from being a single point of failure for traffic leaving switch 130 towards network 110. When any of endpoints 140, 150 or 160 attempts to connect to network 110, security device 220 causes the traffic from any of the respective endpoints to be redirected to the Internet Protocol (IP) address of the security device 220. In some embodiments, security device 220 sends a command and/or policy to switch 130 to redirect any outbound network traffic on switch 130. In other embodiments, security device 220 may only cause a portion of outbound traffic on switch 130 to be redirected. Redirected traffic (e.g., packets) may be ignored, dropped, or forwarded by security device 220 depending on the security policy.

In addition to initiating traffic redirection, security device 220 initiates testing of endpoints whose traffic is being redirected. In some embodiments, security device 220 performs the testing. In other embodiments, security device 220 may send a message and/or command to have another device perform the testing. Endpoint testing can be initiated by seizing control of any endpoint web sessions and directing the endpoint to a test web page that guides a user through the testing. Endpoint testing can also be transparent to an endpoint user in some embodiments.

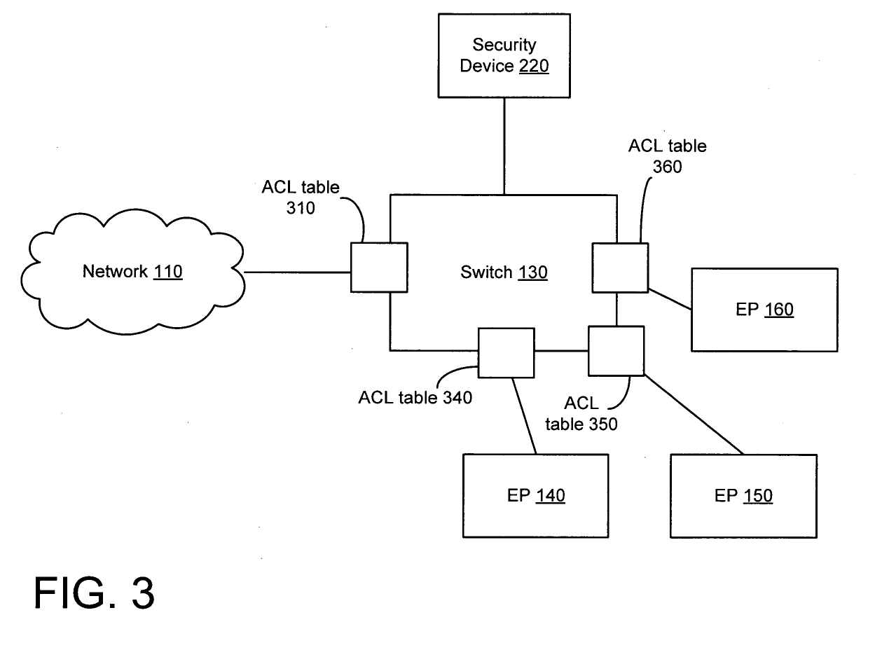

FIG. 3 illustrates access control list (ACL) tables 310, 340, 350 and 360 on switch 130. An ACL is a list of permissions attached to an object. In an ACL-based security model, when a subject requests to perform an operation on an object, the system first checks the list for an applicable entry in order to decide whether or not to proceed with the operation. In some embodiments, security device 220 logs onto switch 130 and adds/updates the ACLs. ACL tables 310, 340, 350 and 360 can be added to a VLAN of the switch or a port of the switch and may include one or more rules. Initially, ACL tables 310, 340, 350 and 360 include a default rule (or default ACL) that causes all outbound traffic, irrespective of the source, to be redirected to security device 220. Once an endpoint has been tested and is found to comply with the security policy, a permit rule for the endpoint is added to the ACL. For example, ACL table 340 might initially include a default rule that causes all traffic from endpoint 140 to be redirected to security device 220. However, once endpoint 140 has been tested and is found to comply with the security policy, security device 220 adds a permit rule (or permit ACL) to ACL table 340 which allows traffic from endpoint 140 to travel to network 110 without being redirected.

Each entry or rule in an ACL typically includes a subject and an action. For example, a rule might specify a particular endpoint (e.g., EP 140) or VLAN and an action (e.g., redirect, block, permit traffic, etc.). Endpoints may be identified in an ACL based on an IP address, media access control (MAC) address, or other type of address or identifier.

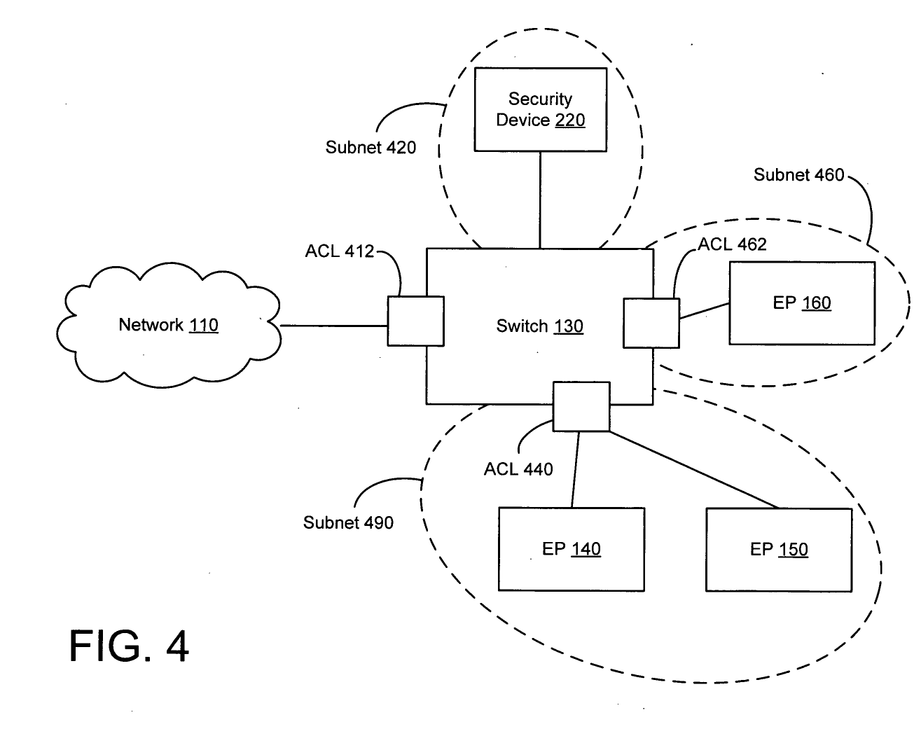

FIG. 4 illustrates network endpoints on different subnets. Endpoints 140 and 150 are on subnet 490 while endpoint 160 is on subnet 460. Security device 220 can also be on a separate subnet (e.g., subnet 420) in some embodiments. Given that endpoints 140 and 150 are on the same subnet, only one ACL is needed for subnet 490. Similarly, a single ACL can be used for all endpoints on the same VLAN.

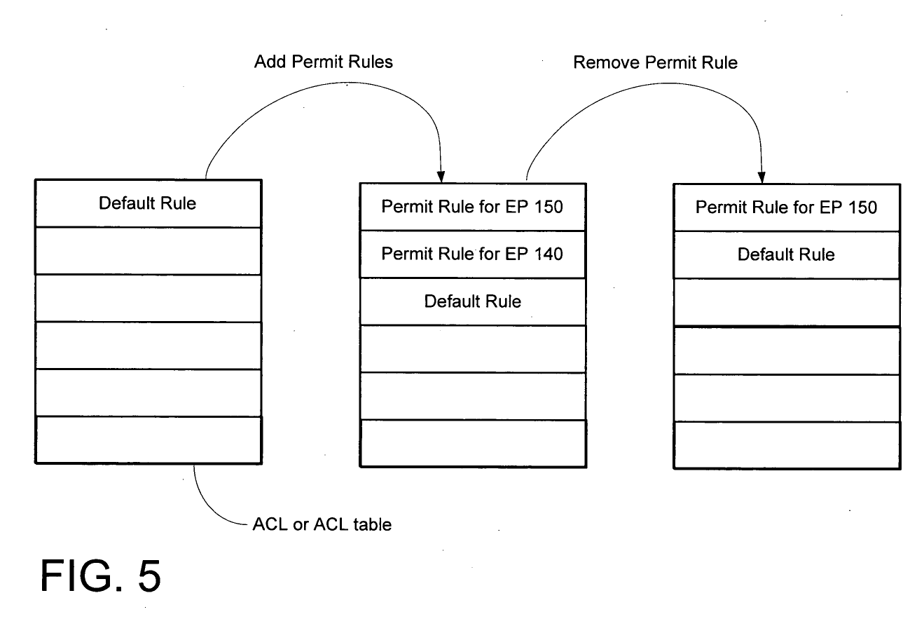

FIG. 5 illustrates an example of rules being added to an ACL table (e.g., ACL tables 310, 340, 350 or 360 of FIG. 3). When an ACL is added to a VLAN or a port of a switch, the ACL is a default rule. The default rule could be specific to a particular endpoint or it could be a general rule that is applied to multiple endpoints (e.g., all endpoints connected to a switch or all endpoints on a VLAN, etc.). Thus, if the default rule is the only ACL in the table, all traffic on the VLAN or port will be controlled by the default rule (e.g., redirected, blocked, forwarded, etc.).

When endpoints are tested and are found to be in compliance with the security policy, permit rules are generated for each compliant endpoint and added to the appropriate ACL table. Referring to FIG. 4, if endpoints 140 and 150 are compliant, then permit rules are added to the table for each endpoint. The ACL table follows a last in, first out (LIFO) processing order. In other words, more recently added rules will be applied to endpoints first. The ACL table does not necessarily follow a LIFO order with respect to adding and removing rules from the table. Given that the default rule is the first rule added to the ACL, the default rule will only be applied to an endpoint if there is no permit rule in the table for the endpoint. Thus, if a permit rule exists for an endpoint, any outbound traffic sent by the endpoint will be allowed through to network 110 because of the permit rule.

The order of the permit rules in the ACL table is not important; if a permit rule exists in the table for a given endpoint, it will be processed before the default rule. Thus, as long as the permit rule exists for an endpoint, traffic will not be redirected.

If an endpoint (e.g., endpoint 140) becomes unavailable for security testing or fails a security test, security device 220 causes the permit rule for endpoint 140 to be removed from the ACL table. As shown in FIG. 5, when the permit rule for endpoint 140 is removed, the permit rule for endpoint 150 remains in the ACL table. Thus, traffic sent from endpoint 150 will still be permitted to reach the network.

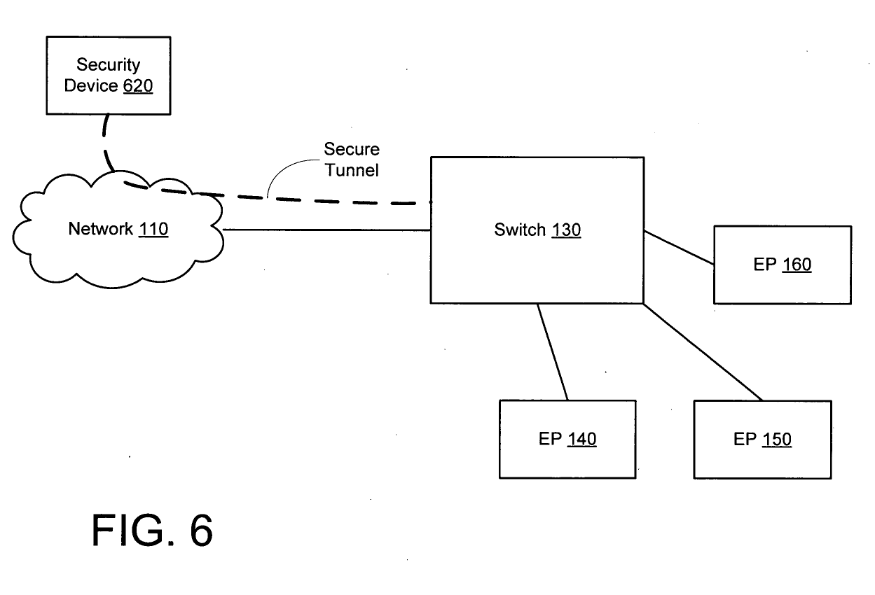

FIG. 6 illustrates a configuration according to some embodiments where a security device 620 is not directly connected to switch 130. Security device 620 communicates ACLs, rules, and otherwise manages the security of endpoints 140,150 and 160 via a secure tunnel through network 110 to switch 130. Secure tunnels can be established by encrypting data (e.g., Transmission Control Protocol (TCP)/IP data, User Datagram Protocol (UDP) data, etc.), masking ports, etc. Secure protocols such as Secure Shell (SSH), IP security (IPsec), Point-to-Point Protocol (PTPP), etc., can be used to establish a secure tunnel between security device 620 and switch 130.

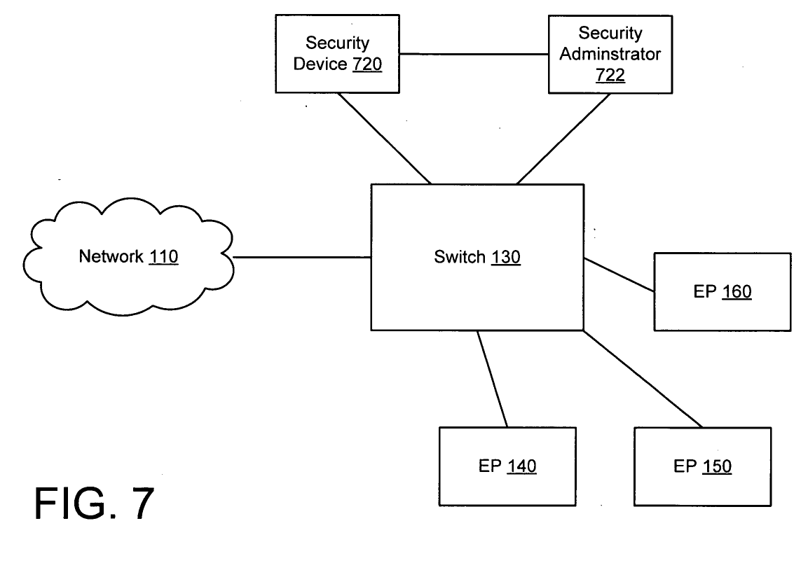

FIG. 7 illustrates a network configuration having a security administrator 722 connected to security device 720. In some embodiments, security device 720 communicates security policies, ACLs, etc. to switch 130 along with handling other functions associated with redirecting and/or permitting traffic from endpoints 140,150 and 160. Security administer 722, used in conjunction with other security software and appliances, facilitates coordination between all security devices on the network and intelligently make decisions about the best way to take action. For example, security administrator 722 may determine that the best course of action is to add an ACL on the switch, or a blackhole entry on a wireless access point, or use a firewall to create a deny rule for a particular endpoint. Security administrator 722 might notify security device 720 if a different security device detects an intrusion, security abnormality, etc. stemming from a particular endpoint. Based on that information, security device 720 could quarantine and retest the suspect endpoint.

Security administrator 722 can be autonomous device or it can be controlled by a user (e.g., system administrator). A system administrator can manually update security policies on security device 720 through security administrator 722 in some embodiments. In other embodiments, the system administrator could modify security policies by directly accessing security device 720.

In some embodiments, an extensible markup language (XML) application programming interface (API) may be used to generate an XML command that shows all VLANs on the switch (or network), parses the VLANs into a format that a user can understand, and creates a check-box for each VLAN. A user can then log onto the security device or security administrator to select VLANs and customize various security policies, tests, etc.

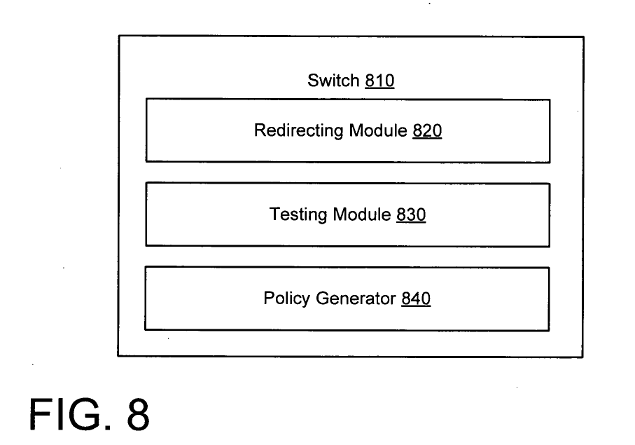

FIG. 8 illustrates various modules on a switch according to some embodiments. Redirecting module 820 controls and manages the redirection of traffic from various endpoints. Testing module 830 initiates and manages testing of endpoints that are not known to comply with one or more security policies. Testing module 830 may perform the testing in some embodiments. Policy generator 840 generates access policies to allow compliant endpoints to access the network without having to redirect the traffic from the endpoint(s). As shown, modules 820, 830, and 840 may all be located on switch 810. Modules 820, 830, and 840 can be implemented as an application specific integrated circuit (ASIC), firmware, a pluggable card that plugs into switch 810, or can be incorporated into a blade CPU that is inserted into switch 810.

In other embodiments, modules 820, 830 and 840 can be located separately or together on various devices and/or components of a system. For example, redirecting module 820 and policy generator 840 might be located on switch 820 while testing module 830 is located on a separate device (e.g., server, etc.). One of skill in the art will recognize that other combinations and configurations could be used.

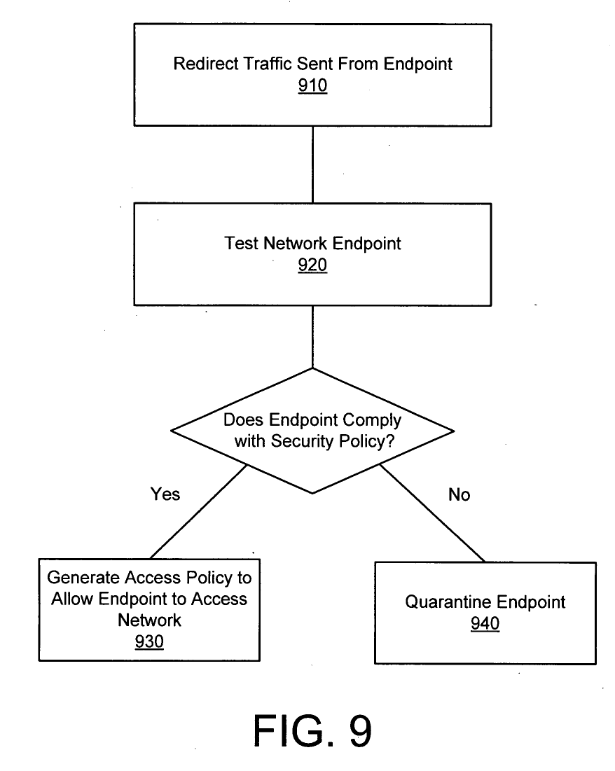

FIG. 9 illustrates a process that may be used in some embodiments. Traffic sent from an endpoint is redirected to a security device or module 910. Having identified the endpoint (e.g., via the source address of the traffic), the endpoint is tested to determine whether the endpoint complies with a security policy 920. If the endpoint complies with the security policy, an access policy is generated to allow the endpoint to access the network 930. If the endpoint fails the testing, the endpoint is quarantined 940 until it is brought into compliance with the security policy (e.g., by updating anti-virus software, installing security patches, etc.)

Each component described herein may be a means for performing the functions described. Each component described herein includes software, hardware, or a combination of these. The components can be implemented as software modules, hardware modules, special-purpose hardware (e.g., application specific hardware), embedded controllers, etc. Software content (e.g., data, instructions, configuration) may be provided via an article of manufacture including a machine readable medium, which provides content that represents instructions that can be executed. The content may result in a machine performing various functions/operations described herein.

A machine readable medium includes any mechanism that provides (e.g., stores and/or transmits) information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.) The terms “machine readable medium” and “computer readable medium” are used interchangeably herein. A machine readable medium may also include a storage or database from which content can be downloaded. A machine readable medium may also include a device or product having content stored thereon at a time of sale or delivery. Thus, delivering a device with stored content, or offering content for download over a communication medium may understood as providing an article of manufacture with such content described herein.

As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method, comprising:
redirecting network traffic sent from an endpoint of a network;
testing the network endpoint for compliance with a security policy; and
generating an access policy to allow the network endpoint to access the network without traffic redirection if the network endpoint is in compliance with the security policy.

2. The method of claim 1, wherein redirecting traffic sent from the network endpoint comprises redirecting network traffic sent from the network endpoint according to a default access control list (ACL) rule installed on a switch.

3. The method of claim 2, wherein generating an access policy comprises generating a permit rule and adding the permit rule to the ACL on the switch.

4. The method of claim 1, wherein redirecting traffic sent from the network endpoint comprises:
blocking outbound traffic from the network endpoint; and
directing the network endpoint to a testing webpage.

5. The method of claim 1, wherein redirecting traffic sent from the network endpoint comprises:
receiving a user selection; and
redirecting network traffic based at least in part on the user selection.

6. The method of claim 5, wherein receiving the user selection comprises receiving the user selection via extensible markup language (XML).

7. The method of claim 5, wherein the user selection comprises a virtual local area network (VLAN) selection.

8. The method of claim 1, wherein redirecting network traffic sent from the network endpoint according to the rule comprises redirecting all network traffic sent from the network endpoint.

9. A method comprising:
generating a default rule for an access control list (ACL) to redirect outbound traffic on a switch belonging to a network;
performing a security test on a network endpoint connected to the switch;
adding a permit rule for the endpoint to the ACL if the endpoint passes the security test; and
quarantining outbound traffic from the endpoint if the endpoint fails the security test.

10. The method of claim 9, further comprising generating an additional redirect rule to redirect inbound traffic from the network on the switch.

11. The method of claim 9, wherein adding a permit rule to the ACL at the switch comprises adding the ACL to one of a VLAN and a port of the switch.

12. An article of manufacture comprising a computer-readable medium having content stored thereon to provide instructions to result in an electronic device performing operations including:
redirecting network traffic sent from an endpoint of a network;
testing the network endpoint for compliance with a security policy; and
generating an access policy to allow the network endpoint to access the network without traffic redirection if the network endpoint is in compliance with the security policy.

13. The article of manufacture of claim 12, wherein redirecting traffic sent from the network endpoint comprises redirecting network traffic sent from the network endpoint according to a default access control list (ACL) rule installed on a switch.

14. The article of manufacture of claim 13, wherein generating an access policy comprises generating a permit rule and adding the permit rule to the ACL on the switch.

15. The article of manufacture of claim 14, further comprising content to cause the electronic device to perform operations including:
blocking outbound traffic from the network endpoint; and
directing the network endpoint to a testing webpage.

16. The article of manufacture of claim 12, wherein redirecting traffic sent from the network endpoint comprises:
receiving a user selection; and
redirecting network traffic based at least in part on the user selection.

17. The method of claim 16, wherein the user selection comprises a virtual local area network (VLAN) selection.

18. A network security system comprising:
a redirecting module to redirect network traffic sent from an endpoint of a network;
a testing module to the network endpoint for compliance with a security policy; and
a policy generator to generate an access policy to allow the network endpoint to access the network without traffic redirection if the network endpoint is in compliance with the security policy.

19. The system of claim 18, wherein the redirecting module, the testing module, and the policy generator are located on one or more network servers.

20. The system of claim 18, wherein the redirecting module and the policy generator are located on a switch connected to the network endpoint.

21. The system of claim 20, wherein the testing module is also located on the switch.

22. The system of claim 18, wherein the redirecting module includes a communication agent to add a default access control list (ACL) rule on a switch to redirect network traffic sent from the endpoint.

23. The system of claim 18, wherein the access policy comprises a permit ACL rule to allow the network endpoint to access the network without traffic redirection.

24. The system of claim 23, wherein the policy generator includes a communication agent to add the permit ACL rule to the switch.
